(19) United States
(12) Patent Application Publication
(10) Pub. No.: US 2010/0081355 A1
(43) Pub. Date: Apr. 1, 2010

(54) SUBSTRATE HOLDING APPARATUS, CARRIER, SUBSTRATE PROCESSING APPARATUS, AND IMAGE DISPLAY DEVICE MANUFACTURING METHOD

(75) Inventors: Masato INOUE, Chigasaki-shi (JP); Shin Matsui, Fujisawa-shi (JP); Yasuo Kato, Kouza-gun (JP)

Correspondence Address: BUCHANAN, INGERSOLL & ROONEY PC, POST OFFICE BOX 1404, ALEXANDRIA, VA, 22313-1404, US

(73) Assignee: CANON ANELVA CORPORATION, Kawasaki-shi (JP)

(21) Appl. No.: 12/568,396

(22) Filed: Sep. 28, 2009

(30) Foreign Application Priority Data
Sep. 30, 2008 (JP) 2008-255175
Sep. 17, 2009 (JP) 2009-215409

(51) Int. Cl. H01J 9/00

(52) U.S. Cl. 445/24; 335/290

(57) ABSTRACT

An apparatus comprises a carrier configured to hold a mask containing a magnetic material and a substrate by magnetically attracting the mask via the substrate, and a controller configured to control the carrier, the carrier including a permanent electromagnet and a first contact, the permanent electromagnet including a variable-polarity magnet, a coil electrically connected to the first contact and generates a magnetic field for changing the polarity of the variable-polarity magnet by an electric current supplied via the first contact, and a fixed-polarity magnet. The controller includes a second contact which is in contact with the first contact and supplies an electric current to the coil via the first contact, a sensor unit which senses a contact state between the first contact and the second contact, and a current supply unit which supplies an electric current to the coil via the first contact and the second contact.

### BACKGROUND OF THE INVENTION

1. Field of the Invention

The present invention relates to a substrate holding apparatus, carrier, substrate processing apparatus, and image display device manufacturing method.

2. Description of the Related Art

When manufacturing a flat panel display, patterns are formed on a substrate such as a glass substrate. Examples of the pattern formation method are vacuum deposition, sputtering, photolithography, and screen printing.

Japanese Patent Laid-Open No. 10-41069 and Japanese Patent No. 3539125 have disclosed methods by which a mask is brought into tight contact with a substrate by using a magnetic force, and deposition is performed in this state. To form fine patterns on a substrate, it is necessary to thin a pattern portion of a mask, improve the adhesion between the pattern portion and substrate, and prevent deflection or wrinkles of the pattern portion. For this purpose, Japanese Patent No. 3539125 has disclosed a method of fixing a metal mask having a thickness of 500 μm or less to a frame while applying tension to the metal mask.

On the other hand, as a method of improving the substrate processability of a substrate processing apparatus, an in-line method (Japanese Patent Laid-Open No. 2002-203885) and an interback method obtained by improving the in-line method are known. In either method, substrates are processed as they are carried through a plurality of processing chambers partitioned from each other. In these methods, each substrate can be carried on rollers as it is held on a carrier.

To form patterns on a substrate, the substrate and a mask can be carried as they are held by a carrier. Japanese Patent Laid-Open No. 10-152776 has disclosed an arrangement that includes a permanent magnet and electromagnet on a plate for holding a substrate, and holds a substrate by magnetically attracting a mask made of a magnetic material via the substrate. In this arrangement, the mask is held by the magnetic force of the permanent magnet, and released by canceling the magnetic force generated by the permanent magnet by a magnetic force generated by the electromagnet.

Japanese Patent Laid-Open No. 2005-246634 has disclosed a permanent electromagnetic chuck incorporating a permanent electromagnet as a mold fixing apparatus. This permanent electromagnetic chuck has a neodymium magnet, an alnico magnet, and a coil wound around the alnico magnet. The polarity of the alnico magnet is controlled by the direction of an electric current supplied to the coil, and maintained even when the electric current supplied to the coil is shut down. To chuck a mold, the polarity of the alnico magnet is controlled such that a magnetic flux formed by the neodymium magnet and alnico magnet passes through a chucking surface. To release a mold, the polarity of the alnico magnet is controlled such that the magnetic flux formed by the neodymium magnet and alnico magnet does not pass through the chucking surface.

The mold fixing permanent electromagnetic chuck disclosed in Japanese Patent Laid-Open No. 2005-246634 is superior in that the chucking state or non-chucking state is maintained even when power supply to the coil is stopped. However, when adopting an arrangement in which the permanent electromagnetic chuck is separated from a controller for controlling the permanent electromagnetic chuck and freely moved, an electric current must be supplied from the controller to the coil of the permanent electromagnetic chuck while a contact of the permanent electromagnetic chuck and that of the controller are in well electrically contact with each other. If this electrical contact between the contacts of the permanent electromagnetic chuck and controller is insufficient, no necessary electric current (e.g., 100 A) is supplied to the coil, and the permanent electromagnetic chuck may cause an operation error. For example, if the permanent electromagnetic chuck is in the non-chucking state although a sequence of controlling the permanent electromagnetic chuck in the chucking state is executed, a mold may fall when the permanent electromagnetic chuck is operated. Also, if the electrical contact is insufficient, discharge (spark) may occur between the contacts, and this may advance deterioration of the contacts. Caution should be particularly exercised in a vacuum environment because discharge readily occurs.

### SUMMARY OF THE INVENTION

The present invention provides a technique of more reliably controlling the state of a carrier having a permanent electromagnet.

A first aspect of the present invention provides a substrate holding apparatus comprising a carrier configured to hold a mask containing a magnetic material and a substrate by magnetically attracting the mask via the substrate, and a controller configured to control the carrier, wherein the carrier includes a permanent electromagnet and a first contact, the permanent electromagnet includes a variable-polarity magnet having variable polarity, a coil which is electrically connected to the first contact and generates a magnetic field for changing the polarity of the variable-polarity magnet by an electric current supplied via the first contact, and a fixed-polarity magnet having fixed polarity, a state of the carrier is set in one of a first state in which the mask and the substrate are held by a magnetic field generated by the variable-polarity magnet and the fixed-polarity magnet, and a second state in which the mask and the substrate are not held, by controlling the polarity of the variable-polarity magnet by the magnetic field generated by the coil, and the controller includes a second contact which is in contact with the first contact and supplies an electric current to the coil via the first contact, a sensor unit which senses a contact state between the first contact and the second contact, and a current supply unit which supplies an electric current to the coil via the first contact and the second contact, if the contact state satisfies a determination criterion.

A second aspect of the present invention provides a carrier which holds a mask containing a magnetic material and a substrate by magnetically attracting the mask via the substrate, comprising a permanent electromagnet, and a first contact, wherein the permanent electromagnet includes a variable-polarity magnet having variable polarity, a coil which is electrically connected to the first contact and generates a magnetic field for changing the polarity of the variable-polarity magnet by an electric current supplied via the first contact, a fixed-polarity magnet having fixed polarity, and a first test contact electrically connected to the first contact and configured to come in contact with a second test contact of an external apparatus, and a state of the carrier is set in one of a first state in which the mask and the substrate are held by a magnetic field generated by the variable-polarity magnet and the fixed-polarity magnet, and a second state in which the mask and the substrate are not held, by controlling the polarity of the variable-polarity magnet by the magnetic field generated by the coil.

A third aspect of the present invention provides a substrate processing apparatus for processing a substrate, comprising the substrate holding apparatus as mentioned above, and a processing chamber which forms a film on a substrate held together with a mask by a carrier of the substrate holding apparatus.

A fourth aspect of the present invention provides a method of manufacturing an image display device, comprising the step of forming a film on a substrate by using the substrate processing apparatus as mentioned above.

Further features of the present invention will become apparent from the following description of exemplary embodiments with reference to the attached drawings.

### BRIEF DESCRIPTION OF THE DRAWINGS

FIG. 1A is an exemplary view showing the arrangement of a substrate holding apparatus of a preferred embodiment of the present invention;

FIG. 1B is an exemplary plan view of a mask;

FIG. 2A is an exemplary view showing a method of connecting a contact (first contact) of a carrier and a contact (second contact) of a current supply unit (controller);

FIG. 2B is an exemplary view showing the arrangement of a temperature control system of a preferred embodiment of the present invention;

FIG. 3 is a view showing an outline of the arrangement of a substrate processing apparatus of a preferred embodiment, of the present invention;

FIGS. 4A and 4B are views showing an example of an image display device manufactured by using the substrate processing apparatus shown in FIG. 3 in a part of the manufacturing process;

FIG. 5 is a view showing another example of the image display device manufactured by using the substrate processing apparatus shown in FIG. 3 in a part of the manufacturing process;

FIGS. 6A to 6E are views showing an example of the manufacturing process of the image display device shown in FIG. 5;

FIG. 7 is a view showing a configuration example of a permanent electromagnet;

FIG. 8 is a view showing the configuration example of the permanent electromagnet;

FIG. 9A is a view for explaining a procedure by which the carrier holds (chucks) a mask and substrate by magnetic attraction;

FIG. 9B is a view for explaining the procedure by which the carrier holds (chucks) the mask and substrate by magnetic attraction;

FIG. 9C is a view for explaining the procedure by which the carrier holds (chucks) the mask and substrate by magnetic attraction;

FIG. 9D is a view for explaining the procedure by which the carrier holds (chucks) the mask and substrate by magnetic attraction;

FIGS. 10A and 10B are views for explaining the principle of a method of sensing the state of the carrier by a sensor unit;

FIG. 11 is a view showing an outline of the arrangement of a preferred embodiment of a portion related to sensing of the contact state according to the present invention; and

FIG. 12 is a view showing an outline of the arrangement of another preferred embodiment of the portion related to sensing of the contact state according to the present invention.

### DESCRIPTION OF THE EMBODIMENTS

Preferred embodiments of the present invention will be explained below with reference to the accompanying drawings.

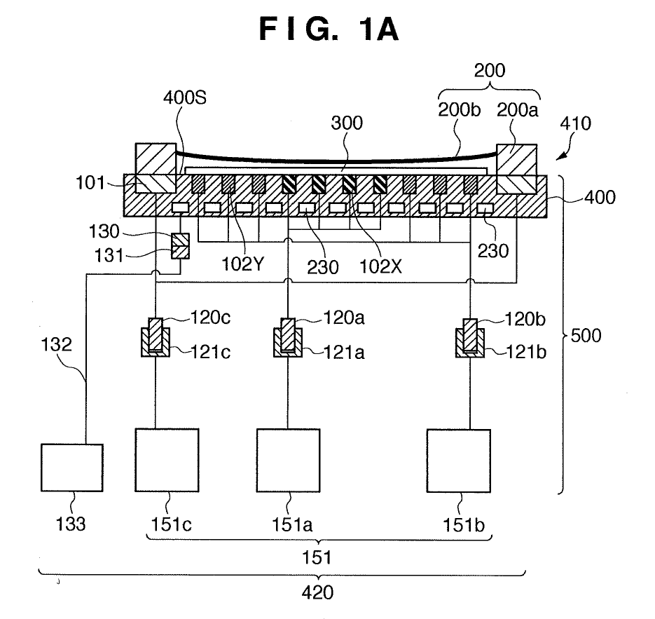

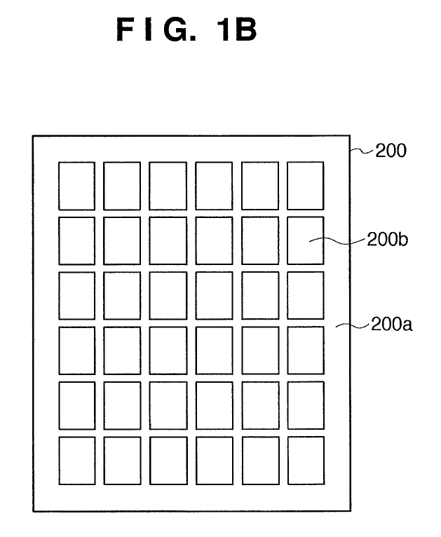

FIG. 1A is an exemplary view showing the arrangement of a substrate holding apparatus of a preferred embodiment of the present invention. A substrate holding apparatus 500 includes a carrier 410 that holds a mask 200 containing a magnetic material and a substrate 300 by magnetically attracting the mask 200 via the substrate 300, and a controller 420 that controls the carrier 410. The carrier 410 can include a support 400 having a holding surface 400S for holding the substrate 300, permanent electromagnets 101, 102X, and 102Y embedded in the support 400, and first contacts 120, that is, 120a, 120b, and 120c.

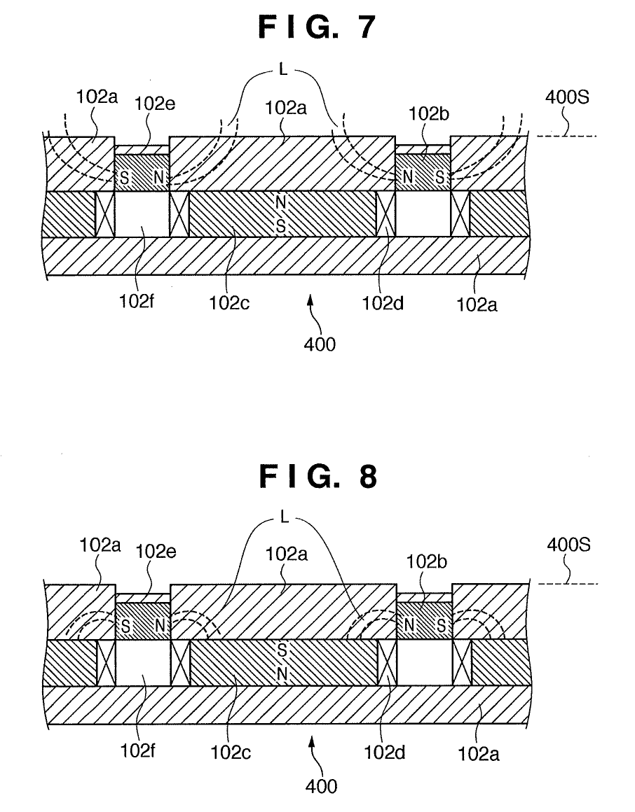

As illustrated in FIG. 7, the permanent electromagnets 101, 102X, and 102Y each include a magnetic material 102a, a variable-polarity magnet (e.g., an alnico magnet) 102c having variable polarity, a coil 102d that is electrically connected to the first contact 120a, 120b, or 120c and generates a magnetic field for changing the polarity of the variable-polarity magnet 102c by an electric current supplied via the first contact 120a, 120b, or 120c, and a fixed-polarity magnet (e.g., a rare-earth magnet such as a neodymium magnet) 102b having fixed polarity. The variable-polarity magnet 102c is a kind of a permanent magnet that inverts the polarity of each of the two poles (N and S poles) in accordance with the direction of an externally applied magnetic field, and maintains the polarity even when the externally applied magnetic field is removed. Since the direction of the magnetic field generated by the coil 102d is reversed when the direction of the electric current to be supplied to the coil 102d is reversed, the polarity of the variable-polarity magnet 102c can be controlled by the direction of the electric current to be supplied to the coil 102d. The first contact 120a, 120b, or 120c is electrically connected to the coil 102d.

The state of the carrier 410 is set (controlled) in one of a first state (attracting state or holding state) in which the mask 200 and substrate 300 are held by a magnetic field generated by the variable-polarity magnet 102c and fixed-polarity magnet 102b, and a second state (non-attracting state or non-holding state) in which the mask 200 and substrate 300 are not held. The state of the carrier 410 is set (controlled) by controlling the direction of the electric current to be supplied to the coil 102d by the controller 420 (the direction of the magnetic field to be generated by the coil 102d).

The controller 420 includes second contacts 121, that is, 121a, 121b, and 121c that come in contact with the first contacts 120a, 120b, and 120c of the carrier 410 and supply an electric current to the coils 102d via the first contacts 120a, 120b, and 120c, a sensor unit (to be described later) for sensing the contact states between the first contacts 120a, 120b, and 120c and second contacts 121a, 121b, and 121c, and a current supply unit 151 for supplying an electric current to the coils 102d via the first contacts 120a, 120b, and 120c and second contacts 121a, 121b, and 121c if the contact states satisfy a determination criterion.

FIG. 1A illustrates the states of the carrier 410, mask 200, and substrate 300 when the alignment of the mask 200 and substrate 300 is complete. The substrate 300 is placed on the holding surface 400S, and the mask 200 is placed on the substrate 300. When forming patterns on the substrate 300 by a film formation method such as vapor deposition, it is generally possible to rotate the carrier 410 through 180° so as to turn it upside down with the mask 200 and substrate 300 being held.

This embodiment uses a plurality of sets of permanent electromagnets, more specifically, the three sets of permanent electromagnets 101, 102X, and 102Y, and these permanent electromagnets can independently be controlled by the controller 420. The permanent electromagnets 101 as the first set are arranged to magnetically attract a mask frame 200a. The permanent electromagnets 102X as the second set are arranged to magnetically attract a central portion in the region of a mask pattern portion 200b. The permanent electromagnets 102Y as the third set are arranged to magnetically attract a peripheral portion (outside the central portion) in the region of the mask pattern portion 200b. The current supply unit 151 of the controller 420 can include a first unit 151c for supplying an electric current to the permanent electromagnets 101 as the first set, a second unit 151a for supplying an electric current to the permanent electromagnets 102X as the second set, and a third unit 151b for supplying an electric current to the permanent electromagnets 102Y as the third set.

The mask 200 includes the mask pattern portion 200b, and the mask frame 200a supporting the mask pattern portion 200b. The mask pattern portion 200b is a sheet-like member having mask patterns. The mask frame 200a and mask pattern portion 200b contain a magnetic material (e.g., a material mainly containing iron). To decrease thermal expansion caused by radiation heat input during vapor deposition, the magnetic material is preferably a low-thermal-expansion material such as an Invar material (an alloy made of 64% of iron and 36% of nickel). Mask patterns are formed on the mask pattern portion 200b by a method such as etching. As the degree of micropatterning of mask patterns increases, demands have arisen for decreasing the thickness of the mask pattern portion 200b.

FIG. 1B is an exemplary plan view of the mask 200. In this example, the mask 200 is a 36-panel mask. Each individual rectangular region surrounded by the mask frame 200a is equivalent to one panel (e.g., one display device). If the thickness of the mask pattern portion 200b as a pattern region is large, the film thickness of a peripheral portion in a fine aperture decreases. Therefore, the mask pattern portion 200b is made thinner than the mask frame 200a. For example, the thickness of the mask pattern portion 200b is sometimes decreased to 0.05 mm or less. By thus thinning the mask pattern portion 200b, even deposition particles obliquely entering a fine aperture can reach the substrate. In a state in which tension is applied to it beforehand, the mask pattern portion 200b can be fixed to the mask frame 200a so as to be surrounded by the mask frame 200a by a method such as welding.

The mask frame 200a is given rigidity by which deformation produced by a counterforce corresponding to the tension applied to the mask pattern portion 200b falls within the range of allowable values. As a consequence, the overall weight of the mask 200 increases. As an example, the weight of a mask having a substrate size of about 1,300 mm×800 mm can reach 300 kg.

A procedure of holding (magnetically attracting) and releasing the substrate 300 and mask 200 will now be explained. FIG. 1A illustrates a state immediately before the substrate 300 and mask 200 are magnetically attracted to the carrier 410 while the controller 420 is connected to the carrier 410 in a work position (normally, a position where the carrier 410 stops). The carrier 410 can be positioned in a predetermined work position of a substrate processing apparatus. After that, the first contacts 120 as the contacts of the carrier 410 and the second contacts 121 as the contacts of the controller 420 are connected. The first contacts 120 and second contacts 121 can be connected by an operating mechanism (not shown). Referring to FIG. 1A, the structure of the first contacts 120 and second contacts 121 is not limited to any specific structure. For example, it is possible to use a structure in which a male connector is pressed into a female connector, a structure in which one is pressed against the other, or another structure.

With the first contacts 120 and second contacts 121 being connected, an electric current for setting the state of the carrier 410 in the first state (attracting state or holding state) is supplied from the current supply units 151, that is, 151a, 151b, and 151c to the coils 102d of the permanent electromagnets 101, 102X, and 102Y via the first contacts 120 and second contacts 121. Consequently, the mask 200 is magnetically attracted by the permanent electromagnets 101, 102X, and 102Y via the substrate 300, and the mask 200 and substrate 300 are held on the holding surface 400S of the carrier 410. After that, the first state is maintained unless an electric current for setting the state of the carrier 410 in the second state (non-attracting state or non-holding state) is supplied to the coils 102d.

After the mask 200 and substrate 300 are held on the holding surface 400S of the carrier 410, the current supply to the coils 102d is shut down, and the first contacts 120 and second contacts 121 are disconnected. In this state, the carrier 410 is transferred in the substrate processing apparatus, and a film (patterns corresponding to the mask pattern portion 200b) is formed on the substrate 300.

When releasing the mask 200 and substrate 300, it is only necessary to connect the first contacts 120 and second contacts 121 again, and, in this state, supply the electric current for setting the state of the carrier 410 in the second state (non-attracting state or non-holding state) from the current supply units 151a, 151b, and 151c to the coils 102d of the permanent electromagnets 101, 102X, and 102Y via the first contacts 120 and second contacts 121.

A configuration example of the permanent electromagnets 101, 101X, and 101Y will be explained below with reference to FIGS. 7 and 8. As described previously, the permanent electromagnet includes the magnetic material 102a, the variable-polarity magnet (e.g., an alnico magnet) 102c having variable polarity, the coil 102d that is electrically connected to the first contact 120a, 120b, or 120c and generates a magnetic field for changing the polarity of the variable-polarity magnet 102c by an electric current supplied via the first contact 120a, 120b, or 120c, and the fixed-polarity magnet (e.g., a neodymium magnet) 102b having fixed polarity. A conductive line connecting the first contact 120a, 120b, or 120c and the coil 102d can be accommodated in a space 102f. Referring to FIGS. 7 and 8, L exemplarily indicates the line of magnetic force of the magnetic field generated by the fixed-polarity magnet 102b. N represents the N pole, and S represents the S pole.

As exemplarily shown in FIG. 7, when the controller 420 supplies an electric current (e.g., 100 A) to the coil 102d in a first direction for a predetermined time (e.g., about 0.5 sec), the polarity of the variable-polarity magnet 102c inverts and becomes the same as that of the fixed-polarity magnet 102b. Consequently, a large amount of magnetic field (magnetic flux) leaks outside the holding surface 400S of the permanent electromagnet, and the mask 200 is magnetically attracted toward the holding surface 400S. This is the first state (attracting state or holding state).

On the other hand, when the controller 420 supplies an electric current (e.g., 100 A) to the coil 102d in a direction opposite to the first direction for a predetermined time (e.g., about 0.5 sec), the polarity of the variable-polarity magnet 102c inverts, and the fixed-polarity magnet 102b and variable-polarity magnet 102c attract each other, that is, no line of magnetic force leaks outside the holding surface 400S, thereby stopping the magnetic attraction of the mask 200. This is the second state (non-attracting state or non-holding state).

In the carrier 410 as described above, an electric current is supplied to the coil 102d when changing the first state to the second state and the second state to the first state, but no electric current need be supplied to the coil 102d in other cases. Therefore, heat generated by the current supply to the coil 102d is negligible. This makes the carrier 410 advantageous when it is used in a low-pressure environment or vacuum environment.

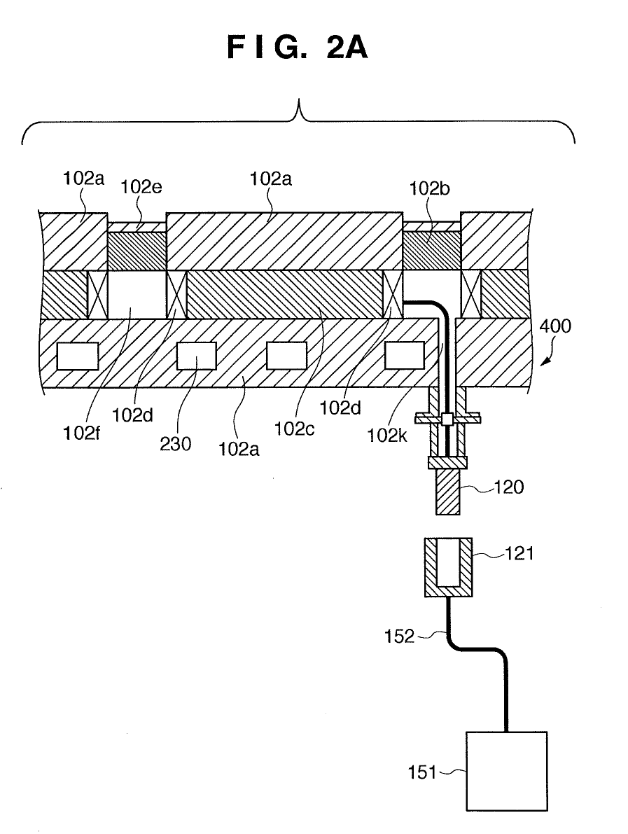

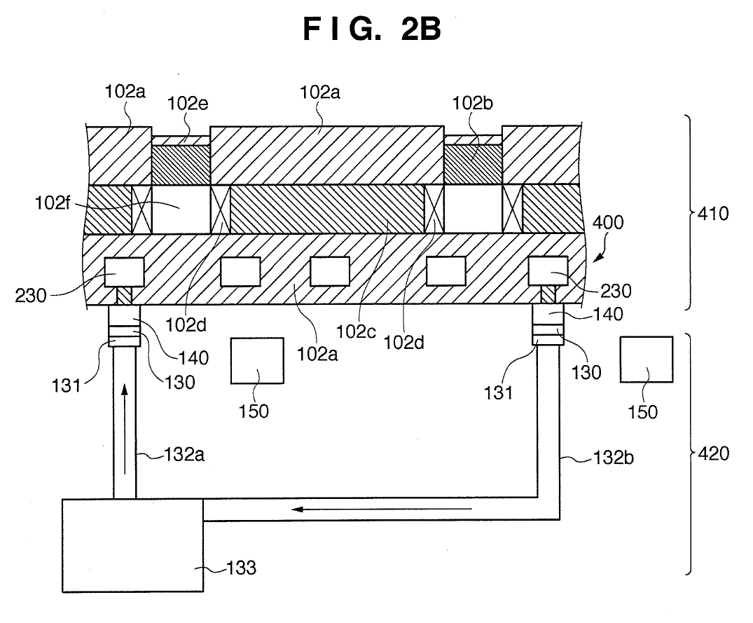

FIG. 2A is an exemplary view showing the method of connecting the first contact 120 and second contact 121. Note that supplying an electric current to the coil of one permanent electromagnet requires two first contacts 120 electrically connected to one terminal and the other terminal of the coil, and two second contacts 121 corresponding to the first contacts 120. FIG. 2A shows only one first contact 120 and one second contact 121. In the example shown in FIG. 2A, the first contact 120 is supported by a contact support portion 120a, and connected to one terminal of the coil 102d via a conductive line 102k.

The first contact 120 and second contact 121 are required to have reliability capable of stably supplying a high electric current (about 100 A) necessary to excite the coil of the permanent electromagnet. If the electrical contact between the first contact 120 and second contact 121 is insufficient, discharge (spark) may occur between the contacts, and deterioration of the contacts may advance as described earlier. Caution should be exercised particularly in a vacuum environment because discharge readily occurs.

In this embodiment, the controller 420 has sensor units for sensing the contact states between the first contacts 120a, 120b, and 120c and the second contacts 121a, 121b, and 121c.

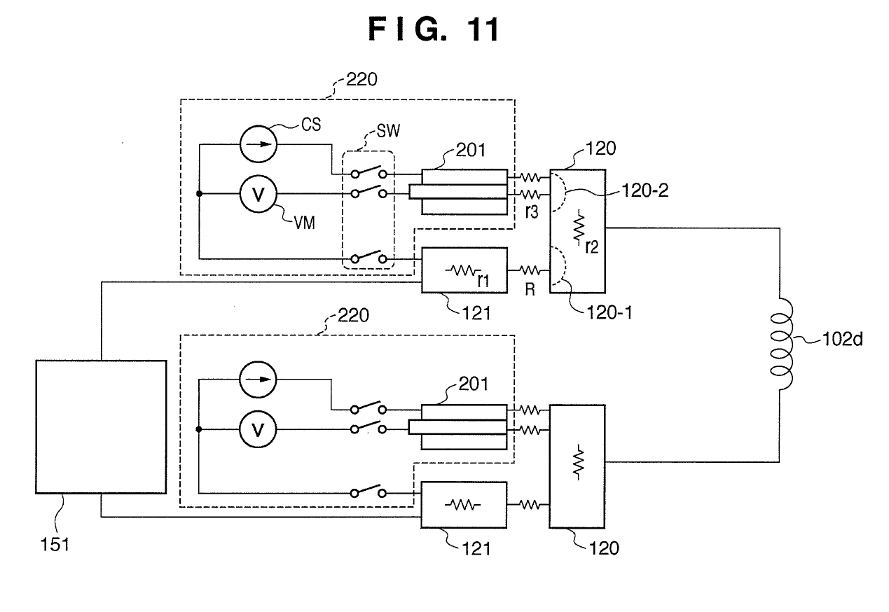

FIG. 11 is a view showing an outline of the arrangement of a preferred embodiment of a portion related to sensing of the contact state according to the present invention. The controller 420 can have one sensor unit 220 for one second contact 121a, 121b, or 121c. The sensor unit 220 senses the contact state between the first contact 120a, 120b, or 120c of the carrier 410 and the second contact 121a, 121b, or 121c of the controller 420 based on a resistance value or voltage drop in the contact portion between the first contact 120a, 120b, or 120c and the second contact 121a, 121b, or 121c.

For example, the sensor unit 220 can be designed to include a test contact 201, and sense the contact state based on a resistance value or voltage drop in a path extending from the test contact 201 to the second contact 121 via the first contact 120, while the second contact 121 is in contact with a first portion 120-1 of the first contact 120 and the test contact 201 is in contact with a second portion 120-2 of the first contact 120. The path can include resistances r1 and r2 in addition to a contact resistance R between (the first portion 120-1 of) the first contact 120 and the second contact 121. The resistance r1 is the resistance of the second contact 121, and the resistance r2 is the resistance between the first portion 120-1 and second portion 120-2 of the first contact 120. The sensor unit 220 can sense the overall resistance value or voltage drop of the path, and can also extract the resistance value of the contact resistance R or the corresponding voltage drop from the overall resistance value or voltage drop. By closing switches SW, an electric current i is supplied from a constant-current source CS through a path including the test contact 201, first contact 120 (resistance r2), resistance R, and second contact 121 (resistance r1), and a voltage drop V between the test contact 201 and second contact 121 is measured by a voltmeter VM. This makes it possible to sense the overall resistance value of the path. Since no electric current flows through the voltmeter VM, a resistance r3 between the test contact 201 and the second portion 120-2 of the first contact 120 has no influence on the measurement value of the voltmeter VM.

By obtaining the resistances r1 and r2 in advance, the contact resistance R can be obtained by

V=i(r1+r2+R)

that is,

R=V/i−r1−r2

The current supply unit 151 of the controller 420 can be designed to supply an electric current to the coil 102d via the first contact 120 and second contact 121 when the contact state (resistance value or voltage drop) sensed by the sensor unit 220 satisfies a determination criterion (e.g., when the resistance value or voltage drop is smaller than a predetermined value).

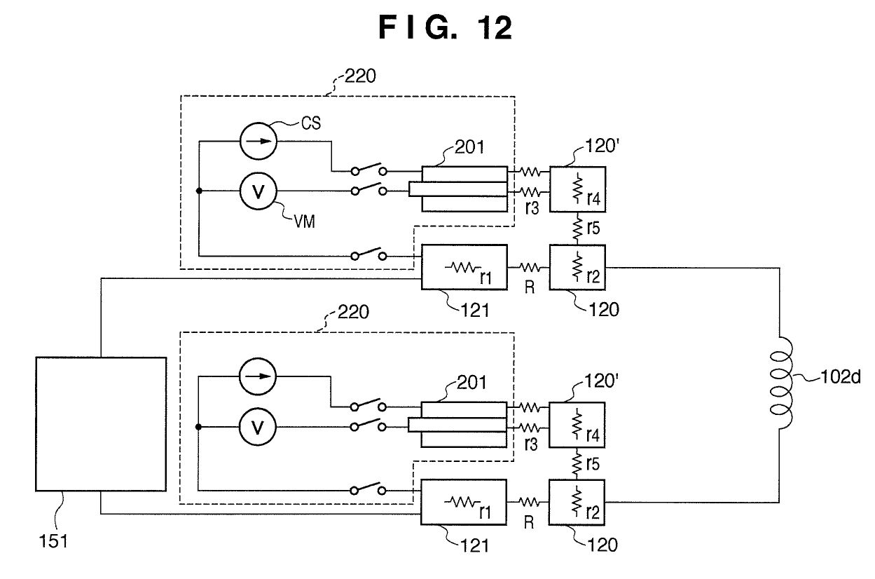

FIG. 12 is a view showing an outline of the arrangement of another preferred embodiment of the portion related to sensing of the contact state according to the present invention. The embodiment shown in FIG. 12 is a modification of the embodiment shown in FIG. 11, and differs from the embodiment shown in FIG. 11 in that the carrier 410 includes a first test contact 120′. When sensing the contact state, a test contact (second test contact) 201 of the controller 420 can be brought into contact with the first test contact 120′ of the carrier 410. The first test contact 120′ of the carrier 410 is electrically connected to the first contact 120 via a conductive line having a resistance value r5.

FIG. 3 is a view showing an outline of the arrangement of a substrate processing apparatus of a preferred embodiment of the present invention. A substrate processing apparatus 30 can be constructed as, for example, a vacuum processing apparatus. First, loading and unloading of the substrate 300 will be explained below. The substrate processing apparatus 30 communicates with evacuation units 402a, 402b, and 402c such as vacuum pumps via valves 401a, 401b, and 401c.

A step of loading, positioning, and fixing the substrate 300 (holding it by the carrier 410) is performed in a loading chamber (first processing chamber) 31. A substrate transfer system (not shown) transfers the substrate 300 to the loading chamber 31. An operating mechanism (not shown) places the transferred substrate 300 on the holding surface of the carrier 410. Also, a mask transfer system (not shown) transfers the mask 200 onto the carrier 410 so as to cover the substrate 300.

The substrate 300 and mask 200 thus transferred are magnetically attracted to the carrier 410 in the loading chamber 31 by connecting the contact (first contact) 120 of the carrier 410 and the contact (second contact) 121 of the current supply unit 151 of the controller 420, and supplying an electric current to the coil of the permanent electromagnet. In this way, preparations for forming a film on the substrate 300 are complete.

After the contact (first contact) 120 of the carrier 410 and the contact (second contact) 121 of the current supply unit 151 of the controller 420 are disconnected, a rotating mechanism installed inside the loading chamber 31 turns the carrier 410 holding the substrate 300 and mask 200 upside down in order to perform deposition in a deposition chamber (second processing chamber) 32. In the deposition chamber 32, a film can be formed on the substrate 300 by a method such as vapor deposition, sputtering, or chemical vapor deposition.

After that, a transfer system (not shown) transfers the carrier 410 holding the substrate 300 and mask 200 to the deposition chamber (second processing chamber) 32, and a film is formed on the substrate 300 by vapor deposition or the like in the deposition chamber 32. For example, the film can be formed while the transfer system (not shown) is transferring the carrier 410 holding the substrate 300 and mask 200. Also, the film can be formed by supplying a material from a material supply unit 34 such as a deposition source to the substrate 300.

When the formation of the film is complete, the transfer system (not shown) transfers the carrier 410 holding the substrate 300 and mask 200 to an unloading chamber (third processing chamber) 33.

Subsequently, a rotating mechanism installed inside the unloading chamber 33 turns the carrier 410 holding the substrate 300 and mask 200 upside down. Then, in the unloading chamber 33, the magnetic attraction by the carrier 410 is canceled by connecting the contact (first contact) 120 of the carrier 410 and the contact (second contact) 121 of the current supply unit 151 of the controller 420, and supplying an electric current to the coil of the permanent electromagnet.

After that, an operating mechanism (not shown) separates the mask 200 and substrate 300 from the carrier 410, and transfers them to their respective transfer systems. The substrate 300 is transferred to an apparatus for the next step.

Note that the loading chamber 31, deposition chamber 32, and unloading chamber 33 may also form a single space.

As described above, the carrier 410 is transferred and undergoes operations such as rotation as it is holding the mask 200 and substrate 300. Accordingly, it is important to ensure that the mask 200 and substrate 300 are held by the carrier 410. Also, if the mask 200 and substrate 300 held by the carrier 410 are removed from it, excessive stress may be applied to the mask 200 and substrate 300.

Accordingly, the substrate holding apparatus 500 preferably has a sensor unit 185 for sensing the state of the carrier 410. For example, the sensor unit 185 includes a magnetic sensor 180 for sensing the magnetic field generated from the permanent electromagnet 101, and the magnetic sensor 180 senses whether the state of the carrier 410 is the first state (attracting state or holding state) or the second state (non-attracting state or non-holding state).

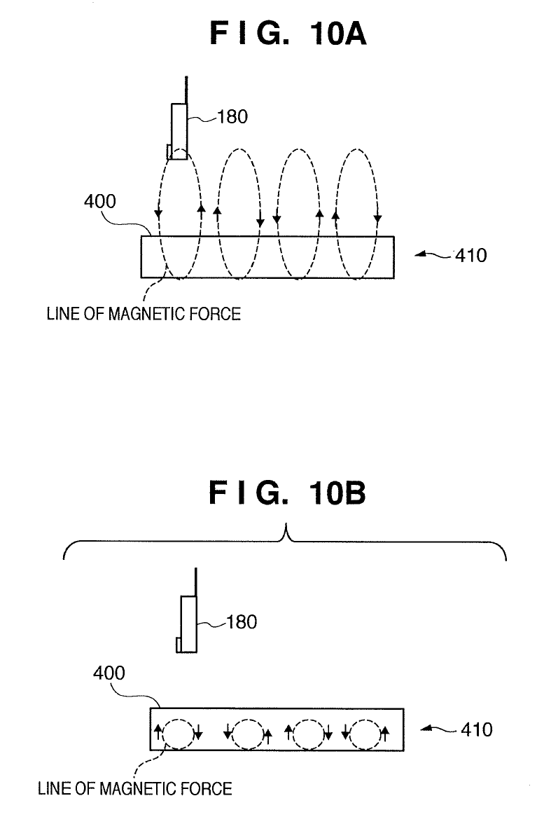

FIGS. 10A and 10B are views for explaining the principle of a method of sensing the state of the carrier 410 by the sensor unit 185. FIG. 10A exemplarily shows the first state (attracting state or holding state). In the first state, a magnetic field (magnetic flux) is generated outside from the support 400 of the carrier 410. Therefore, it is possible to determine that the carrier 410 is in the first state if the measurement value of the magnetic sensor 180 is larger than a determination criterion. FIG. 10B exemplarily shows the second state (non-attracting state or non-holding state). In the second state, no magnetic field (magnetic flux) is generated outside from the support 400 of the carrier 410, or the magnetic field (magnetic flux) is small. Therefore, it is possible to determine that the carrier 410 is in the second state if the measurement value of the magnetic sensor 180 is smaller than the determination criterion.

The sensor unit 185 preferably includes an operating mechanism 182 for operating the magnetic sensor 180. In this embodiment, a hole (preferably, a through hole) 200c is formed in the mask frame 200a of the mask 200 as exemplarily shown in FIG. 3. The operating mechanism 182 is favorably designed to insert the magnetic sensor 180 into the hole 200c. The structure in which the hole 200c is formed in the mask frame 200a and the magnetic sensor 180 is inserted into the hole 200c is useful because the state of the permanent electromagnet 101 (the state of the carrier 410) is sensed while the mask 200 exists on the carrier 410 (i.e., while the mask 200 can be or is magnetically attracted).

In the substrate processing apparatus 30 shown in FIG. 3, the sensor unit 185 is preferably formed in the loading chamber 31 and unloading chamber 33. In the loading chamber 31, after a procedure of setting the permanent electromagnets 101, 102X, and 102Y in the first state (attracting state or holding state) is executed, it is determined that the mask 200 and substrate 300 are completely fixed to the carrier 410 if the sensor unit 185 confirms that the permanent electromagnet 101 is in the first state, and the carrier 410 is transferred or operated.

In the unloading chamber 33, after a procedure of setting the permanent electromagnets 101, 102X, and 102Y in the second state (non-attracting state or non-holding state) is executed, the mask 200 and substrate 300 are removed from the carrier 410 if the sensor unit 185 confirms that the permanent electromagnet 101 is in the second state.

The sensor unit 185 is desirably separated from the carrier 410 in order to simplify an arrangement for supplying power to the sensor unit 185 and communicating with the controller 420, simplify the arrangement of the carrier 410, or control degassing from the magnetic sensor. However, the sensor unit 185 may also be installed in the carrier 410 together with, for example, a battery and wireless communication device.

When forming a film on the substrate 300, the carrier 410 may be heated by, for example, radiation heat from the material supply unit 34 such as a deposition source. Alternatively, a nonuniform temperature distribution may be formed on the carrier 410 by heating or heat dissipation after that. Therefore, temperature control channels 230 for temperature control is favorably formed in the support of the carrier 410. Also, to avoid temperature control pipelines from moving in accordance with the movement of the carrier 410, the temperature control channels 230 preferably have joints 130 for connecting to and disconnecting from (joints 131 of) pipelines 132a and 132b of an external temperature control device. Furthermore, in the carrier 410 as exemplarily shown in FIG. 2B, valves 140 for closing the temperature control channels 230 with a temperature control medium being filled in the temperature control channels 230 are preferably formed inside or near the joints 130.

Although it is also possible to form a single connection port in the temperature control channels 230 and connect the joint 130 and valve 140 to the connection port, it is favorable to form an entrance and exit in the temperature control channels 230 and connect the joints 130 and valves 140 to both of the entrance and exit. In the latter case, it is possible to supply the temperature control medium to the temperature control channels 230 through the entrance with the two valves 140 being open, and collect the temperature control medium from the temperature control channels 230 through the exit, thereby circulating the temperature control medium through the temperature control channels 230.

A temperature control device 133 connects the joints 131 of the pipelines 132a and 132b to the joints 130 of the carrier 410, and circulates the temperature-controlled temperature control medium through a circulating path formed by the pipelines 132a and 132b and the temperature control channels 230 of the carrier 410. The joints 131 and 130 can be connected by an operating mechanism (not shown).

The temperature control device 133 has a control system for controlling the temperature control medium at a target temperature. This control system can include, for example, a temperature controller (including, e.g., a cooler and/or heater), a temperature sensor, and a PID compensator that controls the temperature controller by calculating a manipulated variable based on the deviation between the target temperature and the measurement value of the temperature sensor. It is also possible to install the temperature sensor in the carrier 410 in addition to the temperature control device 133, and provide a temperature measurement value of the temperature sensor installed in the carrier 410 to the temperature control device 133 by a wireless communication device. The temperature sensor and wireless communication device of the carrier 410 can be driven by batteries. The temperature of the carrier 410 can be controlled with high accuracy by measuring the temperature of the carrier 410, and feeding back the measured temperature to the temperature control device 133.

The temperature control device 133 can be designed to cool the carrier 410 to the target temperature, heat the carrier 410 to the target temperature, or reduce a nonuniform temperature distribution.

When the temperature control of the carrier 410 by the temperature control device 133 is complete, the joints 131 of the temperature control device 133 are disconnected from the joints 130 of the carrier 410, and the carrier 410 is transferred. For example, the temperature control device 133 can be designed to control the temperature of the carrier 410 in the loading chamber 31 and/or unloading chamber 33 described above. The temperature control device 133 can be designed to control the temperature of the carrier 410 in a temperature control chamber formed for temperature control.

If the liquid temperature control medium sticks to the carrier 410, particularly, the contacts 120 or holding surface 400S when, for example, the joints 130 of the carrier 410 and the joints 131 of the temperature control device 133 are connected or disconnected, or the pipelines 132a and 132b of the temperature control device 133 are operated, the permanent electromagnets may cause operation errors or defective chucking, the contacts 120 may deteriorate, or the like. Therefore, after the joints 131 of the temperature control device 133 are disconnected from the joints 130 of the carrier 410, it is preferable to remove the temperature control medium from the joins 130 and their peripheries of the carrier 410 by a removing unit 150. The removing unit 150 removes the temperature control medium by a blower that sprays air or the like against the joints 130 and their peripheries of the carrier 410 and/or a wiper that wipes the joints 130 and their peripheries.

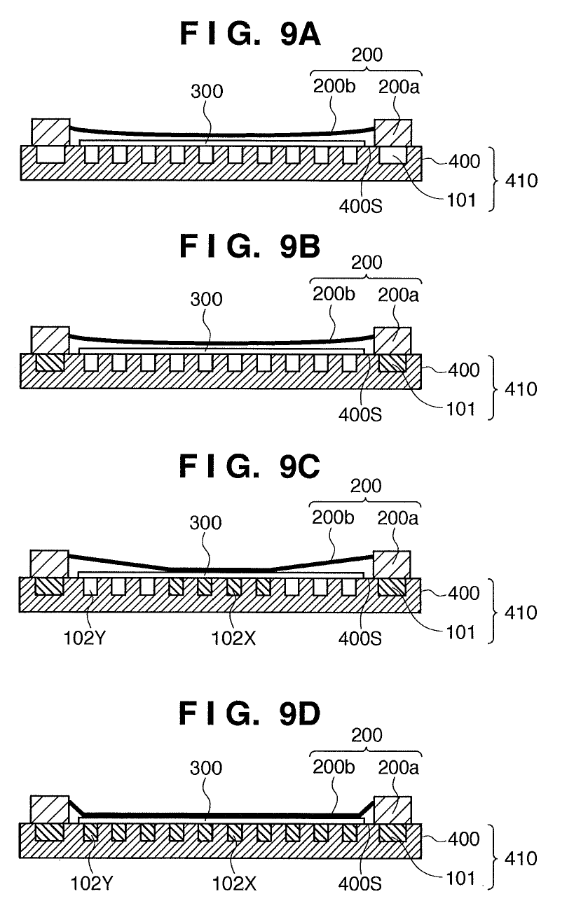

FIGS. 9A to 9D are exemplary views showing a procedure by which the carrier 410 holds (chucks) the mask 200 and substrate 300 by magnetic attraction. Of the permanent electromagnets 101, 102X, and 102Y, hollow portions indicate the non-attracting state (second state), and crosshatched portions indicate the attracting state (first state).

FIG. 9A exemplarily shows a step of aligning the mask 200 and substrate 300. The substrate 300 is set on the holding surface 400S of the support 400, and the mask 200 is set on the substrate 300. An aligning device (not shown) aligns the mask 200 and substrate 300 in the state shown in FIG. 9A. This alignment can be performed by moving either the mask 200 or substrate 300. The alignment can be performed by, for example, observing alignment marks formed in predetermined portions of the substrate 300 and mask 200 by an optical observing device such as a CCD camera, and correcting the difference based on the observation result. When moving the mask 200 and substrate 300 relative to each other, the substrate 300 may be damaged if the mask 200 is in contact with the substrate 300. As exemplarily shown in FIG. 9A, therefore, the alignment is performed with a gap being formed between the mask 200 and substrate 300. If this gap is large, positional deviation may occur when the mask pattern portion 200b and substrate 300 are brought into tight contact with each other in the next procedure. Accordingly, the gap is preferably small, and practically 500 μm or less.

FIG. 9B exemplarily shows a state in which the mask frame 200a is fixed to the carrier 410 by magnetic attraction by controlling only the permanent electromagnets 101 as the first set for holding the mask frame 200a in the first state (attracting state or holding state) by the first unit 151c of the current supply unit 151. Note that as described previously, the three sets of permanent electromagnets 101, 102X, and 102Y can independently be controlled by the first unit 151c, second unit 151a, and third unit 151b.

FIG. 9C exemplarily shows a state in which after the mask frame 200a is fixed to the carrier 410, the central portion of the mask pattern portion 200b is fixed to the carrier 410 by magnetic attraction by controlling the permanent electromagnets 102X as the second set for fixing the central portion of the mask pattern portion 200b in the first state (attracting state or holding state) by the second unit 151a of the current supply unit 151. In this state, the central portions of the substrate 300 and mask 200 are in contact with each other. The central portion of the mask pattern portion 200b is brought into contact with the substrate 300 with tension being applied to the mask pattern portion 200b. When compared to an operation in which the entire surface of the mask pattern portion 200b is brought into contact with the substrate 300 at once, the mask pattern portion 200b can be brought into tight contact with the substrate 300 without producing wrinkles or positional deviation on the mask pattern portion 200b.

FIG. 9D exemplarily shows a state in which after the central portions of the substrate 300 and mask pattern portion 200b are brought into contact with each other, the peripheral portion of the mask pattern portion 200b is fixed to the carrier 410 by magnetic attraction by controlling the permanent electromagnets 102Y as the third set for fixing the peripheral portion of the mask pattern portion 200b in the first state (attracting state or holding state) by the third unit 151b of the current supply unit 151, and as a consequence the mask frame 200a and the central portion and peripheral portion of the mask pattern portion 200b are fixed to the carrier 410.

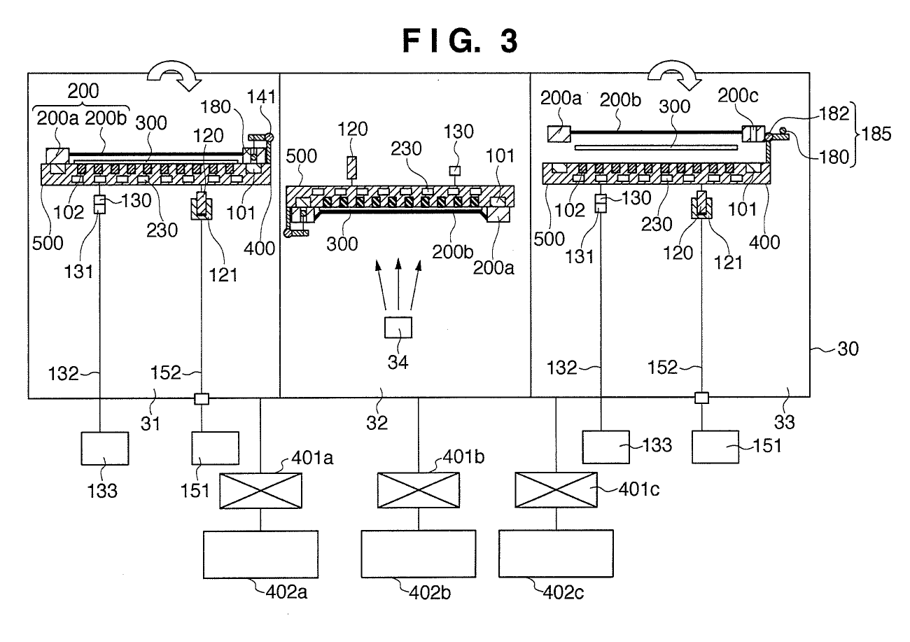

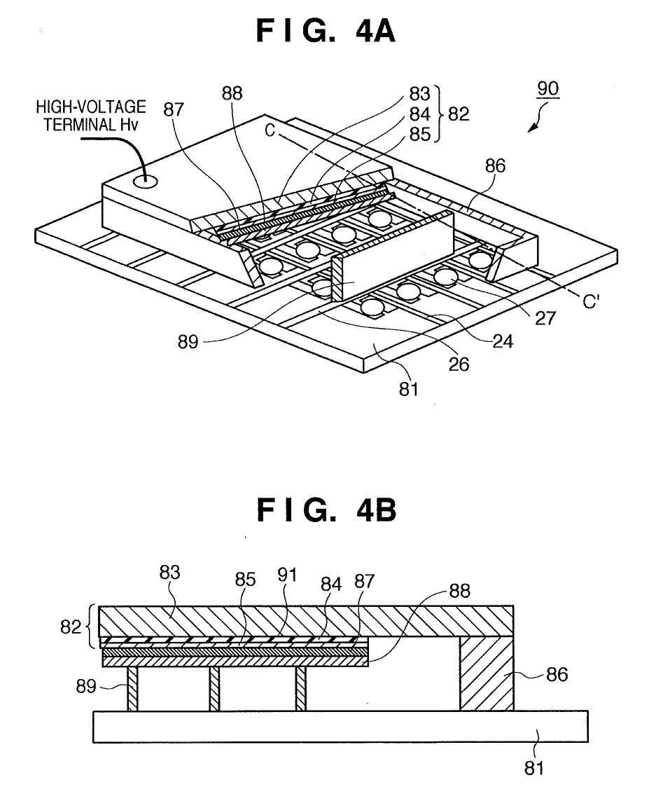

FIGS. 4A and 4B are views showing an example of an image display device manufactured by using the substrate processing apparatus shown in FIG. 3 in a part of the manufacturing process. While an electron source substrate 81 and faceplate 82 are horizontally set with a predetermined distance between them, spacers (support members) 89 are vertically set between the electron source substrate 81 and faceplate 82, and the outer peripheries of the electron source substrate 81 and faceplate 82 are surrounded by a support frame 86. This forms an airtight vessel 90 surrounded by the electron source substrate 81, faceplate 82, and support frame 86. The faceplate 82 has a structure in which a phosphor film 84 and metal back 85 are stacked on a glass substrate 83. The electron source substrate 81 has a structure in which Y-direction lines 24, X-direction lines 26, and conductive portions such as conductive films (element films) 27 are stacked.

To allow the airtight vessel 90 to operate with high reliability, a black conductor 91, nonvolatile getter 87, and volatile getter 88 must be arranged in the internal space of the airtight vessel 90, and they are deposited on the faceplate 82 before assembly. Since the nonvolatile getter 87 and volatile getter 88 must have predetermined patterns, deposition is desirably performed by the substrate processing apparatus 30 by using the carrier 410 holding the mask 200 and substrate 300 such that the mask 200 is overlaid on the substrate 300 as described above.

In the completed image display device, a voltage is applied following a predetermined procedure to the conductive films (element films) 27 through the Y-direction lines 24 and X-direction lines 26 in the electron source substrate 81. Consequently, electrons emitted from the conductive films (element films) 27 collide against the phosphor film 84 of the faceplate 82, thereby forming an image.

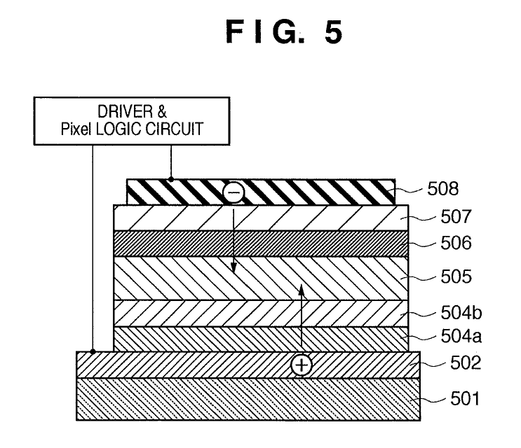

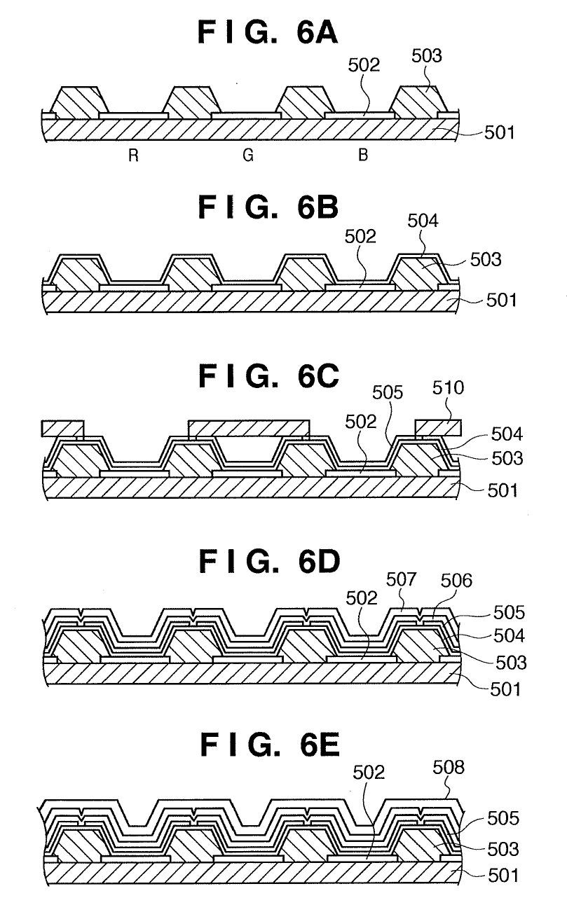

FIGS. 5 and 6A to 6E are exemplary views showing the arrangement of an organic fluorescent display (organic EL display) as an image display device and a method of manufacturing the display by using the substrate processing apparatus shown in FIG. 3 in a part of the manufacturing process.

Reference numeral 501 denotes a glass substrate; 502, an anode; 503, an element isolation layer; 504a, a hole injection layer; 504b, a hole transporting layer; 505, a light emitting layer; 506, an electron transporting layer; 507, an electron injection layer; and 508, a cathode. Note that in FIGS. 6A to 6E, reference numeral 504 denotes a stacked structure of the hole injection layer 504a and hole transporting layer 504b.

When a voltage is applied between the anode electrode 502 and cathode electrode 508, holes are injected into the hole injection layer 504a from the anode electrode 502. On the other hand, electrons are injected into the electron injection layer 507 from the cathode electrode 508. The injected holes move in the hole injection layer 504a and hole transporting layer 504b, and reach the light emitting layer 505. The injected electrons move in the electron injection layer 507 and electron transporting layer 508, and reach the light emitting layer 505. The holes and electrons having reached the light emitting layer 505 recombine and emit light.

Red (R), green (G), and blue (B) as the three primary colors of light can be emitted by appropriately selecting the material of the light emitting layer 505. As a consequence, a full-color image display device can be implemented.

A method of manufacturing the structure shown in FIG. 5 will now be explained with reference to FIGS. 6A to 6E. FIGS. 6A to 6E illustrate one pixel made up of portions that emit R, G, and B. FIGS. 6A to 6E are views showing steps of a general method of manufacturing a light emitting portion of the organic EL display. First, in a pre-step, TFTs (Thin Film Transistors) and interconnections are formed. After that, a conductive film having high reflectance is formed on a substrate 501 such as a glass substrate having undergone a deposition process for planarization. Anode electrodes 502 are formed by patterning the conductive film into predetermined shapes. Then, element isolation films 503 made of a highly insulating material are formed to surround red, green, and blue emitting portions on the anode electrodes 502. Consequently, adjacent light emitting portions R, G, and B are isolated by the element isolation films 503.

Subsequently, a layer 504 including a hole injection layer 504a and hole transporting layer 504b, a light emitting layer 505, an electron transporting layer 506, and an electron injection layer 507 are sequentially formed on the anode electrodes 502 by vapor deposition. The light emitting portion of the organic EL display is formed on the substrate 501 by stacking a cathode electrode 508 made of a transparent conductive film on the electron injection layer 507.

Finally, the above-mentioned light emitting portion on the substrate is covered with a sealing layer (not shown) made of a low-permeability material.

When forming the light emitting layers 505 of R, G, and B by vapor deposition, the substrate is covered with a mask 510 as shown in FIG. 6C. FIG. 6C shows the mask 510 when forming the light emitting portion of R. Accordingly, the light emitting portions of G and B are covered with the mask 510 to prevent a light emitting material of red R from being mixed in the portions of G and B. This light emitting layer formation step is performed when forming the light emitting layers of G and B as well. In a 5.2-inch, full-color organic EL display having 320×240 pixels, for example, the pixel pitch is 0.33 mm (330 μm), and the sub-pixel pitch is 0.11 mm (110 μm). This display requires a mask alignment accuracy of a few μm or less. Also, the hole transporting layer 504b, light emitting layer 505, electron transporting layer 506, and electron injection layer 507 are formed in different chambers in order to prevent mixing of the individual organic materials, and masks specialized for the individual layers are used. Therefore, the masks must accurately be aligned in the same position in these deposition processes.

Accordingly, the ability to rapidly perform mask alignment with high accuracy is important to increase the productivity and yield of the organic EL display.

Also, demands for large-screen displays will probably more and more increase in the future, and this will presumably more and more increase requirements for accurate rapid alignment of large heavy masks.

The above-mentioned substrate holding apparatus and substrate processing apparatus meet the requirements as described above.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-255175, filed Sep. 30, 2008, and Japanese Patent Application No. 2009-215409, filed Sep. 17, 2009, which are hereby incorporated by reference herein in their entirety.

What is claimed is:

1. A substrate holding apparatus comprising:
a carrier configured to hold a mask containing a magnetic material and a substrate by magnetically attracting the mask via the substrate; and
a controller configured to control said carrier,
wherein said carrier includes a permanent electromagnet and a first contact,
said permanent electromagnet includes a variable-polarity magnet having variable polarity, a coil which is electrically connected to said first contact and generates a magnetic field for changing the polarity of said variable-polarity magnet by an electric current supplied via said first contact, and a fixed-polarity magnet having fixed polarity,
a state of said carrier is set in one of a first state in which the mask and the substrate are held by a magnetic field generated by said variable-polarity magnet and said fixed-polarity magnet, and a second state in which the mask and the substrate are not held, by controlling the polarity of said variable-polarity magnet by the magnetic field generated by said coil, and
said controller includes
a second contact which is in contact with said first contact and supplies an electric current to said coil via said first contact,
a sensor unit which senses a contact state between said first contact and said second contact, and
a current supply unit which supplies an electric current to said coil via said first contact and said second contact, if the contact state satisfies a determination criterion.

2. The apparatus according to claim 1, wherein said sensor unit senses the contact state based on one of a resistance value and a voltage drop in a contact portion between said first contact and said second contact.

3. The apparatus according to claim 1, wherein said sensor unit includes a test contact, and senses the contact state based on one of a resistance value and a voltage drop in a path extending from said test contact to said second contact via said first contact, while said second contact is in contact with a first portion of said first contact and said test contact is in contact with a second portion of said first contact.

4. The apparatus according to claim 1, wherein
said carrier further includes a first test contact electrically connected to said first contact, and
said sensor unit includes a second test contact, and senses the contact state based on a voltage drop in a path extending from said second test contact to said second contact via said first test contact and said first contact, while said second contact is in contact with said first contact and said second test contact is in contact with said first test contact.

5. The apparatus according to claim 1, wherein
the mask includes a mask pattern portion and a mask frame which supports the mask pattern portion,
said permanent electromagnet is configured to magnetically attract the mask pattern portion, and
said carrier further includes another permanent electromagnet configured to be controlled independently of said permanent electromagnet, in order to magnetically attract the mask frame.

6. A carrier which holds a mask containing a magnetic material and a substrate by magnetically attracting the mask via the substrate, comprising:
a permanent electromagnet; and
a first contact,
wherein said permanent electromagnet includes a variable-polarity magnet having variable polarity, a coil which is electrically connected to said first contact and generates a magnetic field for changing the polarity of said variable-polarity magnet by an electric current supplied via said first contact, a fixed-polarity magnet having fixed polarity, and a first test contact electrically connected to said first contact and configured to come in contact with a second test contact of an external apparatus, and
a state of said carrier is set in one of a first state in which the mask and the substrate are held by a magnetic field generated by said variable-polarity magnet and said fixed-polarity magnet, and a second state in which the mask and the substrate are not held, by controlling the polarity of said variable-polarity magnet by the magnetic field generated by said coil.

7. The carrier according to claim 6, wherein
the mask includes a mask pattern portion and a mask frame which supports the mask pattern portion,
said permanent electromagnet is configured to magnetically attract the mask pattern portion, and
said carrier further includes another permanent electromagnet configured to be controlled independently of said permanent electromagnet, in order to magnetically attract the mask frame.

8. A substrate processing apparatus for processing a substrate, comprising:
a substrate holding apparatus cited in claim 1, and
a processing chamber which forms a film on a substrate held together with a mask by a carrier of said substrate holding apparatus.

9. A method of manufacturing an image display device, comprising the step of forming a film on a substrate by using a substrate processing apparatus cited in claim 8.
